(19) United States
(12) Patent Application Publication
(10) Pub. No.: US 2006/0172216 A1
(43) Pub. Date: Aug. 3, 2006

(54) Electrophotographic toner and method of development therewith

(75) Inventor: Moriyuki Goto, Shizuoka-shi (JP)

Correspondence Address: OLIFF & BERRIDGE, PLC, P.O. BOX 19928, ALEXANDRIA, VA, 22320, US

(73) Assignee: TOMOEGAWA PAPER CO., LTD., Tokyo (JP)

(21) Appl. No.: 10/545,560

(22) PCT Filed: Feb. 27, 2004
(86) PCT No.: PCT/JP04/02442

§ 371 Date: Aug. 15, 2005

(51) Int. Cl. G03G 9/083; G03G 9/087

(52) U.S. Cl. 430/109.3; 430/106.1; 430/108.6; 430/122

(57) ABSTRACT

Cyclo-olefin copolymer resin is contained as a binder resin, and concentration of a charge controlling agent on the surface of the toner is not less than 0.1 mg/toner 1 g, and less than 1.0 mg/toner 1 g. Furthermore, the toner is held on a non-magnetic sleeve, an electric field is applied between a photoreceptor and the sleeve, and the toner jumps to an electrostatic latent image on the surface of the photoreceptor. In this way, a toner for electrophotography in which image contamination is prevented and deterioration of image density caused by deterioration of jumping property is prevented by maintaining an appropriate amount of charge even in the non-contact developing method using the toner containing cyclo-olefin copolymer resin as a binder resin, can be provided.

### TECHNICAL FIELD

The present invention relates to a toner for electrophotography used in image-forming devices such as copy machines, printers, facsimile machines or the like in which electrophotographic technology is used, and relates to a developing method.

### BACKGROUND ART

As a dry-type developer used in image-forming devices in which electrophotographic technology is used, there are basically three kinds of developers, that is, a two-components developer having a toner and a carrier such as ferrite powder, iron powder, glass beads or the like, a magnetic one-component developer having a toner containing magnetic powder therein, and a non-magnetic one-component developer. A toner used in these developers contains binder resin and coloring agent as a main component, and further contains waxes to improve fixability on recording sheets at low temperatures and releasability from a fusing member, and a charge controlling agent to add polarity (positive charge or negative charge). The toner is prepared by mixing these materials in predetermined ratios, by forming into powder by heat kneading, pulverizing, classifying and the like, and finally, by performing surface treatment using silica, titanium oxide, alumina, and some kinds of resin fine particles to control properties of flowing, charging, cleaning, and storage stability.

Recently, in the above-mentioned image-forming device, both a multifunction and speeding up to spread in boundary region between printing machines and copying machines, and a miniaturization and energy saving to reduce cost (reduction of consumed electric power) are required. With these requirements, not only a simplification of fusing mechanism represented by a heat roll fusing system and an energy saving are required, at the same time, but also adaptation of toner to the fusing system mentioned above, speeding up of printing speed, and an prolonged life of a developer, are required. Therefore, the toner is required to meet contradictory properties, that is, a sufficient fixing property by smaller energy and a high stress resistant property such as resistance to contamination on a charging blade.

To meet the requirements, a toner containing styrene-acrylic based resin as a binder resin has been mainly used conventionally. The toner comprising styrene-acrylic based resin can easily increase the fixing property. However, if too high a fixing property is required, strength of the resin itself is decreased, and there is a problem of insufficient stress resistance, that is, the toner is easily broken by a friction with a sleeve or the like. To compensate for this insufficient stress resistance, polyester based resin is widely used. However, in the toner containing the polyester based resin, the amount of charge under low temperatures and low humidity changes very much, thickness of toner layer on a developing sleeve is increased depending on the increasing of the amount of charge, and as a result, excess amount of developing and fogging may occur. Furthermore, under high temperature and high humidity, amount of charge is insufficient to cause fogging, and then sufficient quality cannot be obtained.

Under such circumstances, as a binder resin for toner which has recently attracted attention, cyclo-olefin copolymer resins can be mentioned, and a toner using such resin is disclosed in Japanese Unexamined Patent Application Publications No. Hei 09-101631 and No. 2000-284528, for example.

On the other hand, as a developing method, a developing method in which one-component developer is used to realize both miniaturization of a developing device and electrophotographic properties, has been suggested and is in practical use. There are two kinds of developing method in which a one-component developer is used. One is a contact-type one-component developing method in which the one-component developer held on a non-magnetic sleeve is contacted and transferred to a photoreceptor having an electrostatic latent image, and the other is a non-contact-type one-component developing method in which a gap of a certain size is given between a non-magnetic sleeve holding one-component developer and a photoreceptor having an electrostatic latent image, and the one-component developer jumps to the electrostatic latent image without contacting to the photoreceptor.

In the contact-type developing method, since the one-component developer on the non-magnetic sleeve contacts the photoreceptor, developing property is good. However, since there is not only friction when the developer is stirred in the developing device but there is also friction when the developer is contacted to the photoreceptor, mechanical stress on the one-component developer is increased.

In the non-contact-type developing method, since the one-component developer is only charged by friction of the charging blade, mechanical stress to the one-component developer is small. However, since developing is performed via the gap, developing property is generally reduced compared to the contact-type developing method. In particular, desirable developing property is difficult to be obtained in the case in which a toner has a small diameter such as several micrometers.

Since cyclo-olefin copolymer resin has high breaking strength, superior stress resistance can be exhibited. Therefore, in the two-components developer, life can be easily extended because fine powder of toner and carrier spent are less generated during friction with the carrier, and in the one-component developer, fine powder of toner and adhesion are less at the time at which the toner is charged by friction by pressing a charging blade made of SUS or silicone rubber to the sleeve. Furthermore, since the cyclo-olefin copolymer resin has low moisture-absorption property, sufficient amount of charge can be obtained under high temperature and high humidity, and fogging does not occur.

Furthermore, it has lower specific gravity and higher intrinsic volume resistance compared to styrene-acrylic acid ester resin or polyester resin, jumping (developing) property and transferring property are superior, and it is suitable for the non-contacting developing method.

However, in the case in which the toner containing cyclo-olefin copolymer resin as a binder resin is used in the non-contacting developing method, electrical charge is easily accumulated during continuous copying of a large number of copies, a toner layer on the sleeve is thickened particularly under low humidity conditions. The outer layer of the toner layer is charged less and image contamination easily occurs, and at the same time, the inner layer of the toner layer is charged more since times of contact with the charging blade is increased and jumping property is decreased, causing reduction of image density.

### DISCLOSURE OF THE INVENTION

An object of the present invention is to provide a toner for electrophotography in which images are not contaminated even if the toner containing cyclo-olefin copolymer resin is used as a binder resin in the non-contacting developing method, and in which image density deterioration caused by jumping property deterioration is prevented by maintaining an appropriate amount of charge.

The toner for electrophotography containing binder resin and charge controlling agent of the present invention contains cyclo-olefin copolymer resin as the binder resin, and concentration of the charge controlling agent on the surface of the toner is not less than 0.1 mg/toner 1 g, and less than 1.0 mg/toner 1 g.

The cyclo-olefin copolymer resin contained in the toner for electrophotography of the present invention has larger breaking strength compared to that of conventional styrene-acrylic acid ester copolymer resin or polyester resin, and therefore, breaking of the toner can be reduced. In this way, not only can toner dusting be reduced but life of the developer also be prolonged. Furthermore, the resin is hardly effected by temperature and humidity, environmental resistance of the toner can be increased. In addition, since specific gravity of the resin is low and intrinsic volume resistance is high, developing (jumping) property and transferring property (transferring efficiency) can be increased.

Furthermore, in the present invention, since concentration of the charge controlling agent on the surface of the toner containing cyclo-olefin copolymer resin is not less than 0.1 mg/toner 1 g, and less than 1.0 mg/toner 1 g, deterioration of image density, fogging, and fogging of photoreceptor can be prevented even if a large number of copies are made continuously by the non-contacting developing method.

The toner of the present invention can contain magnetic material, coloring agent, releasing agent or the like if necessary. The toner particle can be added fluidizing agent such as hydrophobic silica or titanium oxide, and other external additive agents if necessary.

The developing method of the present invention has steps of holding the above-mentioned toner on a non-magnetic sleeve, applying an electric field between the photoreceptor and the sleeve, and jumping of the toner to an electrostatic latent image on the photoreceptor to form an image.

### BRIEF DESCRIPTION OF THE DRAWINGS

FIG. 1 is a schematic diagram showing a device used in the non-contacting magnetic one-component developing method which is one embodiment of the present invention.

### BEST MODE FOR CARRYING OUT THE INVENTION

The present invention is further explained below. The cyclo-olefin copolymer resin used in the toner particle of the present invention is a polyolefin resin having a ring structure unit, for example, a copolymer of α-olefin such as ethylene, propylene, butylene, or the like (acyclic olefin) and cyclo-olefin having double bonds such as cyclohexene, norbornene, tetracyclododecene, or the like. The copolymer can be a random copolymer or a block copolymer. These cyclo-olefin copolymers can be obtained by a conventional polymerizing method in which metallocene based or Ziegler based catalyst is used. In addition, the cyclo-olefin copolymer can be modified by introducing a carboxylic group. For example, methods disclosed in Japanese Unexamined Patent Application Publication No. Hei 05-339327, No. Hei 05-9223, and No. Hei 06-271628 can perform to synthesize the copolymer.

In the present invention, one kind of the cyclo-olefin copolymer resin obtained by the above-mentioned method can be used, or a mixture of plural kinds of cyclo-olefin copolymer resins having different average molecular weight can be used.

In the present invention, other kinds of resins can be used with the above-mentioned cyclo-olefin copolymer resin in the binder resin. The ratio of the cyclo-olefin copolymer resin in the binder resin is desirably in a range from 50 to 100 wt %, and more desirably in a range from 80 to 100 wt %. In the case in which the ratio of the cyclo-olefin copolymer resin is less than 50 wt %, it will become difficult to provide toner for electrophotography having high developing property and high transferring property, which can maintain sufficient image density under any environment, does not generate black spots (hereinafter referred to as “BS”) generated by film formation on the photoreceptor, and does not generate contamination on developing members.

As other resins which can be used with the cyclo-olefin copolymer resin, polystyrene resin, polyacrylic acid ester resin, styrene-acrylic acid ester copolymer resin, styrene-methacrylic acid ester copolymer resin, polyvinyl chloride, polyvinyl acetate, polyvinylidene chloride, phenol resin, epoxy resin, polyester resin, hydrogenated rosin, cyclized rubber, polylactic acid resin, terpene phenol resin, polyolefin resin or the like can be mentioned. In particular, a resin which can increase viscosity of toner when melted is desirable to prevent paper wrapping to fusing roller when the toner is fused. Therefore, it is desirable that the melting start temperature (softening point) be relatively high (e.g., from 120 to 150° C.), and that the glass transition temperature be not less than 65° C. to improve storage stability.

As magnetic material used if necessary, for example, a metal such as cobalt, iron, nickel or the like; an alloy of aluminum, cobalt, copper, iron, nickel, magnesium, tin, zinc, gold, silver, selenium, titanium, tungsten, zirconium or other metals; a metal oxide such as aluminum oxide, iron oxide, or nickel oxide; strong magnetic ferrite, magnetite, or mixture thereof; can be used. As the ferrite, mixed sintered materials of MeO-Fe₂O₃ can be used. In this case, MeO is an oxide of Mn, Zn, Ni, Ba, Co, Cu, Li, Mg, Cr, Ca, V or the like, and one or more kinds thereof can be used. As the magnetite, mixed sintered materials of FeO—Fe₂O₃ can be used. Average particle diameter of the magnetic material is not limited in particular, but is desirably in a range from 0.05 to 3 μm, and the contained amount of the magnetic material is not limited in particular but is desirably in a range from 10 to 65 wt % of the magnetic toner if it is used in the magnetic one-component developing method. In the case in which the contained amount is less than 10 wt %, the amount of charge is increased and image density is decreased easily, and in the case in which the contained amount is more than 65 wt %, intrinsic resistance of the magnetic toner is decreased and developing is difficult to perform.

The concentration of the charge controlling agent on the surface of the toner of the present invention is required to be not less than 0.1 mg per 1 g of toner, and less than 1.0 mg per 1 g of toner. In the case in which the concentration is less than 0.1 mg, fogging and photoreceptor fogging is increased when a large number of copies is made continuously, and in the case in which the concentration is more than 1.0 mg, appropriate image density cannot be obtained.

As a positive charge controlling agent for toner for electrophotography of the present invention, for example, basic dyes, aminopilin, pyrimidine compounds, multinuclear polyamino compounds, aminosilanes, and a filler surface treated by above-mentioned compounds or the like, can be mentioned. More practically, Black 1, 2, 3, 5, 7 or the like of classification of color index C. I. Solvet (oil soluble dye) is desirable.

As a negative charge controlling agent, a compound having a carboxylic group (for example, alkylsalicylic acid metal chelate or the like), metal complex salt dye, fatty acid soap, naphthenic acid metal salt or the like can be mentioned, in particular, a complex salt azo dye containing chromium, iron, or cobalt, which is soluble in alcohol, can be used. More desirably, sulfonylamine derivatives of copper phthalocyanine, or metal-containing monoazo type dye of 2:1 type shown in Chemical Formula 1 can be mentioned. 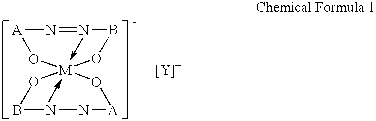
(In the formula, A is a residue of a diazo component having a phenolic hydroxyl group at the ortho position, B is a residue of coupling component, M is chromium, iron, aluminum, zinc or cobalt atom, [Y]⁺ is an inorganic or organic cation)

The charge controlling agent is added in a range from 0.1 to 10 parts by weight and desirably in a range from 0.5 to 8 parts by weight to 100 parts by weight of a binder resin.

As a method to control the concentration of the surface of the toner within the range mentioned above, a method in which the contained amount of the charge controlling agent is controlled, is generally mentioned. In the case in which the contained amount is constant, the surface concentration can be controlled by changing the period and stress of a preliminary mixing process and melting kneading process during the production process of the toner for electrophotography having mixing, kneading, and pulverizing processes.

For example, if the preliminary mixing time is short, shearing force by mixing is not much applied on the charge controlling agent, and the agent is mixed and kneaded while retaining relatively large size in the binder resin. Therefore, after producing the toner by pulverizing and classifying, the charge controlling agent exists in relatively large size on the surface of the toner, and therefore increases the surface concentration.

On the other hand, if the preliminary mixing time is long, shearing force by mixing is much applied on the charge controlling agent and breaks the agent, and the agent is uniformly dispersed in the binder resin. Therefore, the amount of the charge controlling agent exposed on the surface of the toner particle, that is, surface concentration, is low. Furthermore, since the length of the above-mentioned period of the preliminary mixing time and surface concentration of the toner have a proportional relationship, the surface concentration can be controlled by controlling the preliminary mixing time.

In addition, if the stress during the melting kneading process is large, the charge controlling agent is broken finely and dispersed uniformly in the binder resin. Therefore the amount of charge controlling agent exposed on the surface of the toner particle after breaking is decreased.

It should be noted that finer control of the surface concentration can be accomplished by combining the controlling of contained amount of the charge controlling agent, preliminary mixing, and melting kneading.

In the present invention, it is desirable that wax be contained to improve fixability at low temperature and releasability at fusing. As the wax, polyolefin based wax such as polyethylene wax, polypropylene wax or the like, synthesized wax such as Fischer-Tropsch wax or the like, petroleum wax such as paraffin wax, microcrystalline wax or the like, carnauba wax, candelilla wax, rice wax, hydrogenated castor oil or the like can be mentioned. In addition, for the purpose of controlling micro-dispersion of wax in the cyclo-olefin copolymer resin, it is desirable to use modified polyethylene wax. Two or more kinds of these waxes can be used together, also. The amount of the wax contained is desirably in range from 0.5 to 10.0 wt % in the toner particle, and more desirably in a range from 1.0 to 8.0 wt %. In the case in which the amount contained is less than 0.5 wt %, fixability at low temperature and releasability at fusing is not sufficient, and in the case in which the amount contained is more than 10.0 wt %, storage stability is not sufficient.

Plural kinds of wax can be used if necessary; it is desirable that all the waxes used have melting points shown by the endothermic peak of DSC in a range from 80 to 160° C. In the case in which the melting point is less than 80° C., blocking of toner particles easily occurs, and there is a problem of durability, and in the case in which the melting point is more than 160° C., fixing strength is reduced.

Measuring method of the melting point (endothermic peak of DSC) is as follows. About 10 mg of sample was put in an aluminum cell, the cell was placed in a differential scanning calorimeter (DSC) (trade name: SSC-5200, produced by Seiko Instruments Inc.), and N₂ gas was blown at 50 ml per minute. A process in which temperature was increased from 20 to 180° C. at a rate of 10° C. per minute and then decreased from 180 to 20° C. rapidly, was repeated 2 times, and the endothermic peak temperature at that time (i.e., the second time) was measured.

As a black pigment for the coloring agent, carbon black or lamp black can be mentioned, as a magenta pigment, C. I. pigment red 1, 2, 3, 4, 5, 6, 7, 8, 9, 10, 11, 12, 13, 14, 15, 16, 17, 18, 19, 20, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209; C. I. pigment violet 19; C. I. violet 1, 2, 10, 13, 15, 23, 29, 35 or the like can be mentioned, as a cyan pigment, C. I. pigment blue 2, 3, 15, 16, 17; C. I. vat blue 6; C. I. acid blue 45 or the like can be mentioned, and as a yellow pigment, C. I. pigment yellow 1, 2, 3, 4, 5, 6, 7, 10, 11, 12, 13, 14, 15, 16, 17, 23, 65, 73, 74, 83, 97, 155, 180 or the like can be mentioned. These are used alone or in combination. As a general name of a coloring agent which is commonly used, carbon black, aniline blue, calco oil blue, chrome yellow, ultramarine blue, Dupont oil red, quinoline yellow, methylene blue chloride, phthalocyanine blue, malachite green oxalate, lamp black, rose Bengal or the like can be mentioned. The coloring agent is required to be sufficiently contained to form visible images having sufficient density. For example, it is contained in a range from about 1 to 20 parts by weight, desirably in a range from 1 to 7 parts by weight, to 100 parts by weight of the binder resin.

Toner particle used in the toner of the present invention can be produced by mixing the above-mentioned raw materials in a predetermined ratio, melting and kneading the mixture, pulverizing into powder, and classifying. Alternatively, the toner particle can be produced by using a polymerizing method using raw materials of the above-mentioned materials. Volume average particle diameter of the toner particle is generally set in a range from 5 to 15 μm.

Hydrophobic silica fine particles as fluidizing agent is desirably adhered to the toner particle in a range from 0.2 to 3.0 wt %, and more desirably in a range from 0.5 to 2.5 wt %. In the case in which the adhered amount of the hydrophobic silica fine particle is less than 0.2 wt %, releasing agent contained in the toner particle is adhered to photoreceptors or charging members, and defects in images may easily occur. In the case in which the adhered amount is more than 3.0 wt %, the hydrophobic silica may easily fall off from the toner particles, and BS on the photoreceptor may be generated.

Furthermore, it is desirable that titanium oxide be adhered to the toner of the present invention. Flowing property is further improved by the titanium oxide, developing property is improved, and image density can be exhibited more. The primary average particle diameter of hydrophobic silica fine particle and titanium oxide are desirably less than 0.10 μm. In addition, particles having large diameter, middle diameter, and small diameter can be used in combination if necessary. In this way, more reliable property of adhesion resistance can be obtained.

In addition, magnetic powder, alumina, talc, clay, calcium carbonate, magnesium carbonate, or some kinds of resin particles can be adhered to the toner to control flowing property, charging property, cleaning property, and storage stability of the toner.

To adhere the above-mentioned fine particles on the toner particles, a method in which a commonly used agitator such as a turbine-type agitator, Henschel mixer, super mixer or the like is used, can be mentioned.

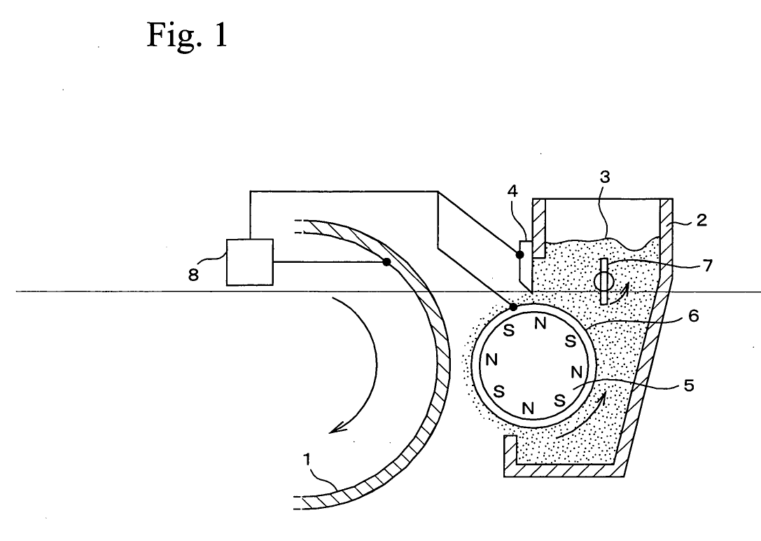

Regarding the developing method of the present invention, an embodiment of the magnetic one-component developing method is explained as follows. FIG. 1 is a schematic diagram showing a device used in the magnetic one-component developing method of non-contacting type. The developing device comprises a cylindrical photoreceptor drum 1 which is an electrostatic latent image holder, a hopper 2 containing a magnetic one-component developer 3, an aluminum non-magnetic sleeve 6 whose right half circumference is contained in the hopper 2 and left half circumference is faced with the photoreceptor drum 1 and which is placed at a position to have certain gap with the photoreceptor drum 1, a magnet roller 5 set in the non-magnetic sleeve 6, a magnetic blade 4 which makes uniform the thickness of the layer of the magnetic one-component developer 3 held on the non-magnetic sleeve 6, an agitator 7 which agitates the magnetic one-component developer 3 in the hopper 2, and an electric power source 8 which keeps the non-magnetic sleeve 6 and magnetic blade 4 in an electrically conductive state and which applies alternating current bias voltage and direct current bias voltage to the photoreceptor drum 1.

The non-contacting magnetic one-component developing method using above-mentioned device is performed as follows. First, an electrostatic latent image is formed on the surface of the photoreceptor drum 1 by a conventional method for electrophotography. On the other hand, the magnetic one-component developer 3 in the hopper 2 is held on the surface of the non-magnetic sleeve 6 having the magnetic roller 5 inside, to make the layer of the magnetic one-component developer 3 uniform by the magnetic blade 4, and the developer 3 is carried. The electric power source 8 applies alternating current bias voltage and direct current bias voltage to the photoreceptor drum 1, direct current electric field and alternating electric field are generated between the non-magnetic sleeve 6 and the photoreceptor drum 1, and therefore the magnetic one-component developer 3 on the surface of the non-magnetic sleeve 6 jumps to the electrostatic latent image on the photoreceptor drum 1 to be developed.

The present invention is further explained by way of Examples and Comparative Examples. However, the present invention is not limited to the range thereof

1. Preparation of Toner for Electrophotography

### EXAMPLE 1

### Preparation of Toner A

| | | |
|---|---|---|
| Cyclo-olefin copolymer resin (trade | 60 | parts by weight |
| name: TOPAS COC, produced by | | |
| Ticona GmbH, ethylene-norbornene | | |
| copolymer) | | |
| Fischer-Tropsch wax (trade name: | 4 | parts by weight |
| FT-100, produced by Nippon Seiro Co., | | |
| Ltd., melting point: 92° C.) | | |
| Charge controlling agent (trade | 1 | part by weight |
| name: T-77, produced by Orient Chemical | | |
| Industries, Ltd., 2:1 type iron | | |
| complex salt monoazo dye) | | |
| Magnetite (trade name: EPT-1000, | 35 | parts by weight |
| produced by Toda Kogyo CORP.) | | |

Raw materials having ratios shown above were premixed by a super mixer for 10 minutes, heat melted and kneaded by a biaxial extruder at a rotation speed of 150 rpm, pulverized by a jet mil, and classified by a dry-type air flow classifier, to obtain toner particles having volume average particle diameter of 8 μm.

0.5 wt % of hydrophobic silica (trade name: R-972, produced by Nippon Aerosil Co., Ltd., primary average particle diameter: 0.016 μm) and 0.5 wt % of the weight of the toner particle of hydrophobic titanium oxide (trade name: NKT-90, produced by Nippon Aerosil Co., Ltd., primary average particle diameter: 0.013 μm) were added to the obtained toner particles, and they were mixed by a Henschel mixer for 3 minutes at a circumferential velocity of 40 m/sec, to obtain Toner A.

### EXAMPLE 2

### Preparation of Toner B

Except that the preliminary mixing by the super mixer was performed for 5 minutes, Toner B of the present invention was obtained in a manner similar to that in Example 1.

### EXAMPLE 3

### Preparation of Toner C

Except that the preliminary mixing by the super mixer was performed for 15 minutes, Toner C of the present invention was obtained in a manner similar to that in Example 1.

### EXAMPLE 4

### Preparation of Toner D

Except that the heat melting and kneading by the biaxial extruder was performed at rotation speed of 200 rpm, Toner D of the present invention was obtained in a manner similar to that in Example 1.

### COMPARATIVE EXAMPLE 1

### Preparation of Toner E

Except that polyester resin (trade name: FC-433, produced by Mitsubishi Rayon Co., Ltd.) was used as the binder resin, Toner E of the Comparative Example was obtained in a manner similar to that in Example 1.

### COMPARATIVE EXAMPLE 2

### Preparation of Toner F

Except that styrene-acrylic acid ester copolymer resin (trade name: Dianal FB-1157, produced by Mitsubishi Rayon Co., Ltd.) was used as the binder resin, Toner F of the Comparative Example was obtained in a manner similar to that in Example 1.

### COMPARATIVE EXAMPLE 3

### Preparation of Toner G

Except that the premixing by the super mixer was performed for 1 minute, Toner G of the Comparative Example was obtained in a manner similar to that in Example 1.

### COMPARATIVE EXAMPLE 4

### Preparation of Toner H

Except that the premixing by the super mixer was performed for 2 minute, Toner H of the Comparative Example was obtained in a similar manner in Example 1.

### COMPARATIVE EXAMPLE 5

### Preparation of Toner I

Except that the heat melting and kneading by the biaxial extruder was performed at a rotation speed of 275 rpm, Toner I of the Comparative Example was obtained in a manner similar to that in Example 1.

2. Measuring of Concentration of Charge Controlling Agent on the Surface of Toner

The concentration of the charge controlling agent on the surface of the obtained toners was measured by the following method. 0.1 g of the toner was put in a screw tube, 50 ml of methanol was added, the mixture was stirred for 10 minutes, and was allowed to stand for 24 hours. The supernatant liquid was poured into a cell, and an absorbance at a wavelength specified by each charge controlling agent was measured by a spectrophotometer (trade name: UV-365, produced by Shimadzu Corporation) in a range from 350 to 1000 nm. Using a standard curve which was made in advance for each charge controlling agent, concentration of the charge controlling agent of the supernatant liquid was calculated by the Lambert-Bert's law. From the concentration of the charge controlling agent in the supernatant liquid, concentration of the charge controlling agent on the surface of the toner (mg/toner 1 g) was calculated. The results are shown in Table 1.

3. Evaluation of Toner

Using each toner A to I, copying in which an A4 original having an image ratio of 6% was copied onto A4 copy paper, was performed 10,000 times by a commercially available facsimile printer using a non-contacting magnetic one-component developing method (trade name: UG-3313, produced by Matsushita Electric Industrial Co., Ltd.) under environmental conditions of temperature 110° C. and relative humidity 20%, and image density (ID), fogging (BG), fogging of photoreceptor (PCBG) were evaluated. Image density (ID) was evaluated by measuring the solid image by Macbeth reflection densitometer (trade name: RD-914). Fogging (BG) was evaluated by measuring the whiteness of the non-image part before and after copying by a color meter (trade name: ZE2000, produced by Nippon Denshoku Industries Co., Ltd.), and the whiteness thereof were compared. Fogging of photoreceptor (PCBG) was evaluated by forcibly cutting off electric power during a printing operation, taking a fogging on the photoreceptor before transferring by an adhesive tape (produced by Sumitomo 3M LIMITED), putting the tape on an A4 copy paper, and measuring the density using a Macbeth reflection densitometer. The results are shown in Table 1. ◯ is less than 0.20, Δ is in a range from 0.20 to 0.30, and X is more than 0.30.

TABLE 1

| | | Concentration of | | | | | | |
|---|---|---|---|---|---|---|---|---|
| | | Charge Controlling | Initial | | | After 10,000 times | | |
| | Toner | Agent | ID | BG | PCBG | ID | BG | PCBG |
| Example 1 | A | 0.71 | 1.40 | 0.68 | ◯ | 1.38 | 0.55 | ◯ |
| Example 2 | B | 0.90 | 1.39 | 0.56 | ◯ | 1.35 | 0.39 | ◯ |
| Example 3 | C | 0.35 | 1.41 | 0.78 | ◯ | 1.45 | 0.67 | ◯ |
| Example 4 | D | 0.14 | 1.42 | 0.81 | ◯ | 1.44 | 0.80 | ◯ |
| Comparative | E | 0.93 | 1.48 | 1.21 | X | 1.40 | 1.81 | X |
| Example 1 | | | | | | | | |
| Comparative | F | 0.54 | 1.39 | 0.86 | ◯ | 1.20 | 1.03 | Δ |
| Example 2 | | | | | | | | |
| Comparative | G | 1.46 | 1.30 | 0.77 | ◯ | 0.67 | 0.22 | ◯ |
| Example 3 | | | | | | | | |
| Comparative | H | 1.10 | 1.33 | 0.70 | ◯ | 1.19 | 0.36 | ◯ |
| Example 4 | | | | | | | | |
| Comparative | I | 0.08 | 1.37 | 0.10 | Δ | 1.49 | 5.56 | X |
| Example 5 | | | | | | | | |

As is clear from Table 1, in Examples 1 to 4, image density was not less than 1.35, fogging was not more than 0.81, fogging of photoreceptor was less than 0.20 from the first copy until the 10,000th copy. In Comparative Example 1, fogging was substantial since the polyester resin was used. In Comparative Example 2, image density was decreased, fogging was increased, and fogging of the photoreceptor occurred after 10,000 copies because the styrene-acrylic acid copolymer resin was used. In Comparative Example 3, since concentration of the charge controlling agent on the surface was high, image density was low. In Comparative Example 4, since concentration of the charge controlling agent on the surface was somewhat high, the amount of charge was increased after 10,000 copies and image density was decreased. In Comparative Example 5, since concentration of the charge controlling agent on the surface was low, amount of charge was decreased and developing could not be controlled, resulting in fogging and fogging of photoreceptor after 10,000 copies.

In this way, the toner of the present invention can exhibit superior jumping properties and developing properties even under conditions of low temperature and low humidity.

As explained above, in the present invention, by containing cyclo-olefin copolymer resin as a binder resin, and by the concentration of charge controlling agent on the surface of the toners ranging from not less than 0.1 mg/toner 1 g, and less than 1.0 mg/toner 1 g, a toner for electrophotography in which images are not contaminated and deterioration of image density caused by deterioration of jumping property is prevented by maintaining appropriate amount of charge even in the non-contacting developing method, can be provided.

1. A toner for electrophotography containing:
a binder resin containing at least cyclo-olefin copolymer resin; and
a charge controlling agent,
wherein concentration of the charge controlling agent on the surface of the toner is not less than 0.1 mg/toner 1 g, and less than 1.0 mg/toner 1 g.

2. The toner for electrophotography according to claim 1, wherein the toner for electrophotography further contains magnetic material.

3. The toner for electrophotography according to claim 1, wherein the toner further contains hydrophobic silica and titanium oxide as external additive agents.

4. A developing method comprising steps of:
holding the toner according to claim 1 on a non-magnetic sleeve;
applying an electric field between a photoreceptor and the sleeve; and
making the toner jump to an electrostatic latent image on the surface of the photoreceptor to form an image.

5. The toner for electrophotography according to claim 1, wherein the cyclo-olefin copolymer resin is contained in the binder resin at 50 to 100 wt %.

6. The toner for electrophotography according to claim 1, wherein the charge controlling agent is contained 0.1 to 10 parts by weight to 100 parts by weight of the binder resin.

7. The toner for electrophotography according to claim 1, wherein the toner contains a wax having a melting point in a range from 80 to 160° C. in a range from 0.5 to 10.0 wt %.

8. The toner for electrophotography according to claim 3, wherein the hydrophobic silica in a range from 0.2 to 3.0 wt % is adhered to the toner particle.
